(19) United States
(12) Patent Application Publication
(10) Pub. No.: US 2022/0050259 A1
(43) Pub. Date: Feb. 17, 2022

(54) LENS ASSEMBLY

(71) Applicant: Newmax Technology Co., Ltd., Taichung City (TW)

(72) Inventor: Yung-Fu Liang, Taichung City (TW)

(21) Appl. No.: 17/032,296

(22) Filed: Sep. 25, 2020

(30) Foreign Application Priority Data
Aug. 14, 2020 (TW) 109127636

(51) Int. Cl. G02B 7/02

(52) U.S. Cl. CPC G02B 7/021; G02B 7/022

(57) ABSTRACT

A lens assembly is provided, including a barrel, defining an axial direction and including an object side and an image side, an inner circumferential wall of the barrel including a stage portion extending inwardly, a first barrel side wall and a second barrel side wall, the stage portion including a first stage face facing the image side, the first barrel side wall being oblique to the axial direction and located between the first stage face and the second barrel side wall; and at least one optical member, mounted to the barrel, including a first face facing the first stage face and a first optical member side wall abutted against the first barrel side wall.

### BACKGROUND OF THE INVENTION

### Field of the Invention

The present invention relates to a lens assembly.

### Description of the Prior Art

Generally, a lens assembly includes a barrel and at least one optical member (for example, including a lens, a shading sheet, a spacer) which is disposed in the barrel. The barrel has an object side and an image side which opposite to each other axially, an inner circumferential wall of the barrel has a stage portion which is annular and near the object side, and the stage portion defines a light entrance hole which expands toward the object side. Through using a mechanic device to assemble a lens from the image side into the barrel and abut against the stage portion, an outer periphery of the lens is tight fit to the inner circumferential wall of the barrel to be assembled with each other. During the process of mounting the lens, the mechanic device exerts a pressure toward the stage portion to ensure the lens is stably assembled. However, the pressure could make the stage portion deform easily, positions of each optical member of the lens assembly could shift, and there may problems like lower assembly precision or lower efficiency of the lens assembly.

The present invention has arisen to mitigate and/or obviate the afore-described disadvantages.

### SUMMARY OF THE INVENTION

The major object of the present invention is to provide a lens assembly, and the lens assembly has a barrel which will deform easily and has a preferable assembly precision.

To achieve the above and other objects, a lens assembly is provided, including a barrel, defining an axial direction and including an object side and an image side, an inner circumferential wall of the barrel including a stage portion extending inwardly, a first barrel side wall and a second barrel side wall, the stage portion including a first stage face facing toward the image side, the first barrel side wall being oblique to the axial direction and located between the first stage face and the second barrel side wall; and at least one optical member, mounted to the barrel, including a first face facing the first stage face and a first optical member side wall abutted against the first barrel side wall.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferred embodiment of the present invention;

FIG. 2 is a breakdown view of the first preferred embodiment of the present invention;

FIG. 3 is a cross-sectional view of the first preferred embodiment of the present invention;

FIG. 4 is a partially enlarged view of FIG. 3;

FIG. 5 is a cross-sectional view of a second preferred embodiment of the present invention;

FIG. 6 is a partially enlarged view of FIG. 5;

FIG. 7 is a partially cross-sectional view of a third preferred embodiment of the present invention;

FIG. 8 is a partially cross-sectional view of a fourth preferred embodiment of the present invention;

FIG. 9 is a cross-sectional view of a fifth preferred embodiment of the present invention;

FIG. 10 is a partially enlarged view of FIG. 9;

FIG. 11 is a cross-sectional view of a sixth preferred embodiment of the present invention;

FIG. 12 is a partially-enlarged view of FIG. 11;

FIG. 13 is a cross-sectional view of a seventh preferred embodiment of the present invention;

FIG. 14 is a partially-enlarged view of FIG. 13;

FIG. 15 is a cross-sectional view of an eighth preferred embodiment of the present invention;

FIG. 16 is a partially-enlarged view of FIG. 15;

FIG. 17 is a cross-sectional view of a ninth preferred embodiment of the present invention;

FIG. 18 is a partially-enlarged view of FIG. 17;

FIG. 19 is a cross-sectional view of a tenth preferred embodiment of the present invention;

FIG. 20 is a partially-enlarged view of FIG. 19;

FIG. 21 is a cross-sectional view of an eleventh preferred embodiment of the present invention;

FIG. 22 is a partially-enlarged view of FIG. 21;

FIG. 23 is a cross-sectional view of a twelfth preferred embodiment of the present invention; and

FIG. 24 is a partially-enlarged view of FIG. 23.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

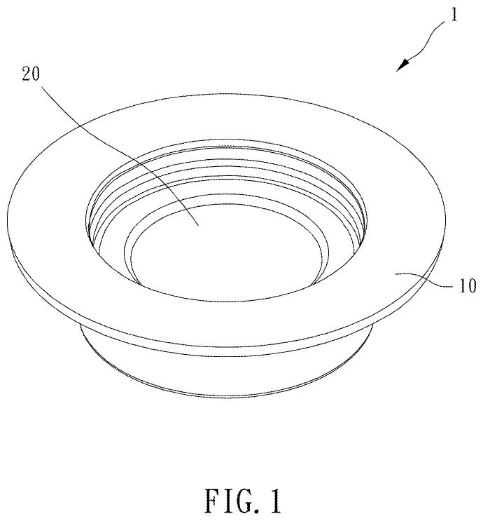

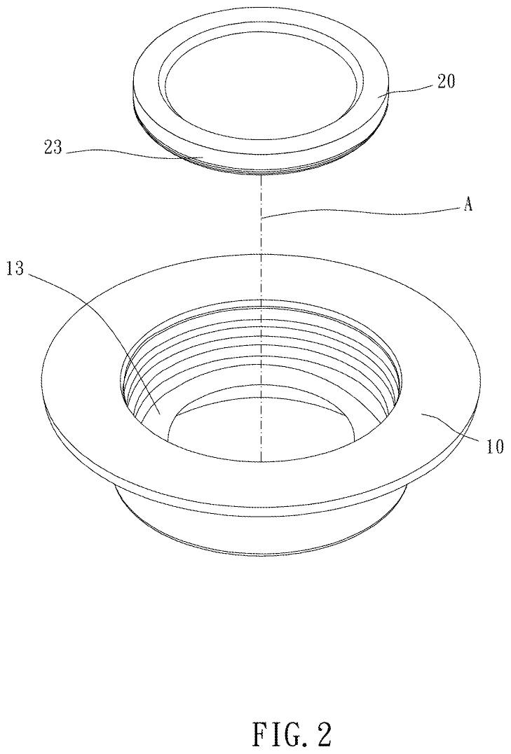

Please refer to FIGS. 1 to 4 for a first preferred embodiment. A lens assembly 1 includes a barrel 10 and at least one optical member 20.

The barrel 10 defines an axial direction A and includes an object side 11 and an image side 12, an inner circumferential wall of the barrel 10 includes a stage portion 13 extending inwardly, a first barrel side wall 14 and a second barrel side wall 15, the stage portion 13 includes a first stage face 131 facing toward the image side 12, and the first barrel side wall 14 is oblique to the axial direction A and located between the first stage face 131 and the second barrel side wall 15. The at least one optical member 20 is mounted to the barrel 10 and includes a first face 21 facing the first stage face 131 and a first optical member side wall 22 abutted against the first barrel side wall 14, so that the stage portion 13 will not easily deform due to contact force in the axial direction A during the mounting process of the at least one optical member 20, and the assembling precision would be preferable.

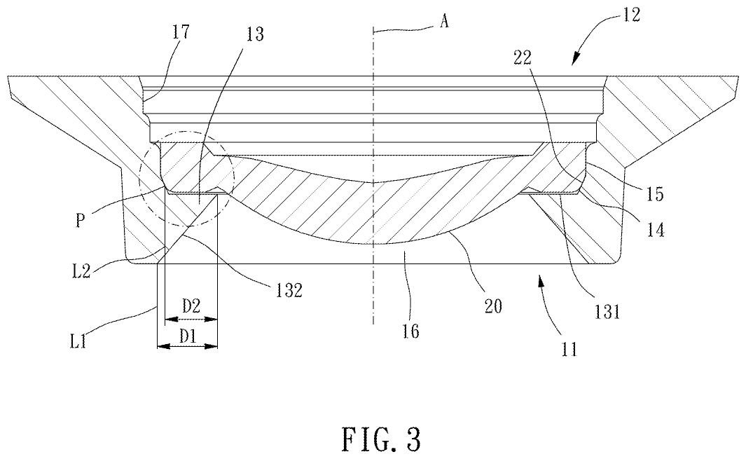

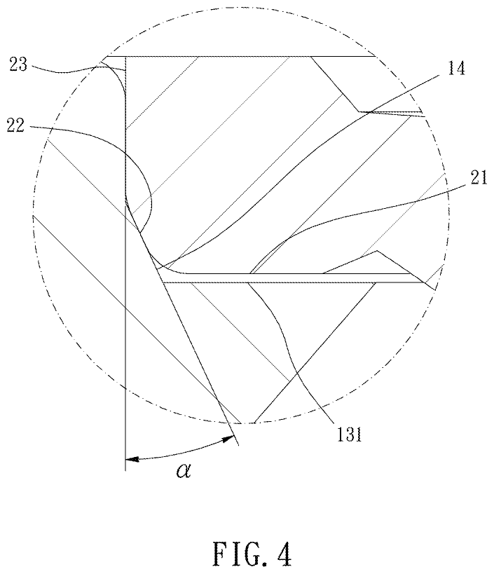

Please refer to FIGS. 3 and 4, the first barrel side wall 14 is transitionally connected to the first stage face 131, the second barrel side wall 15 is parallel to the axial direction A, and the first stage face 131 is perpendicular to the axial direction A; however, the first stage face 131 may be designed to be oblique to the axial direction A. The first barrel side wall 14 is obliquely connected to the first stage face 131 and the second barrel side wall 15, models of the first barrel side wall 14 tilting toward the axial direction A include at least one of an inclined plane, an inclined convex surface and an inclined concave surface, the first barrel side wall 14 and the first optical member side wall 22 are abutted against each other in at least one of three ways: multi-points contact, line contact and surface contact, so as to make a pressure of mounting the at least one optical member 20 disperse laterally to effectively prevent the stage portion 13 from being deformed because of directly bearing a forward force transmitting along the axial direction A. In this embodiment, a smallest inner diameter of the first barrel side wall 14 is equal to or smaller than a smallest outer diameter of the first optical member side wall 22 to make the at least one optical member 20 and the barrel 10 mounted to each other more stably. The first face 21 is perpendicular to the axial direction A and parallel to the first stage face 131, there is a gap between the first face 21 and the first stage face 13 to ensure the stage portion 13 will not be pressed and deformed by the forward force along the axial direction A when mounting the at least one optical member 20, but the first stage face 131 may also be designed to be oblique to the axial direction A. In this embodiment, the first barrel side wall 14 is an inclined plane which is annular, an included angle α between the inclined plane and the axial direction A is between 1 and 89 degrees, and the optical option is between 15 and 45 degrees which can stably abut against the at least one optical member 20 to effectively and laterally disperse the forward force when mounting the at least one optical member 20.

It is understandable that when the first barrel side wall 14 is abutted against the first optical member side wall 22, the first face 21 partly contacts the first stage face 131 but not abuts against the first stage face 131.

Please refer to FIG. 3, the stage portion 13 further includes a slant face 132 which is oblique to the axial direction A and oppositely arranged relative to the first stage face 131, and the slant face 132 defines a light entrance hole 16 which radially expands toward the object side 11. A line which passes through an outer periphery of the slant face 132 and is parallel to the axial direction A is defined as a first straight line L1; a point which the first barrel side wall 14 contacts the first optical member side wall 22 is defined as a contact position P, a line which passes through the contact position P and parallel to the axial direction A is defined as a second straight line L2, and a distance D2 between the second straight line L2 and an inner periphery of the stage portion 13 is equal to or greater than ⅓ of a distance D1 between the first straight line L1 and the inner periphery of the stage portion 13. In FIG. 3, the first barrel side wall 14 and the first optical member side wall 22 are in a face contact relationship and define a face contact area, and any point within the face contact area which matches the above definition (D2≥⅓×D1) can be defined as the contact position P; in other embodiments, the first optical member side wall may be arc-shaped, the first optical member side wall and the first barrel side wall are in a point contact relationship, and a tangent point of the first optical member side wall and the first barrel side wall is the contact position P. In this embodiment, the second straight line L2 is near the first straight line L1, the contact position P corresponds to a position of the stage portion 13 which is axially thicker, a pressure along the axial direction A can be guided through the first barrel side wall 14 laterally or obliquely to the position of the stage portion 13 which is thicker and has greater structure strength, so a position of the stage portion 13 which is axially thinner can be prevented from force deformation.

The inner circumferential wall of the barrel 10 further includes a plurality of annular walls 17 which are steppedly arranged, and each said optical member 20 is abutted against one of the plurality of annular walls 17 to provide preferable assembling stability. Specifically, the at least one optical member 20 further includes a second optical member side wall 23 which extends along the axial direction A, the first optical member side wall 22 is connected to and between the second optical member side wall 23 and the first face 21, and the second optical member side wall 23 is abutted against the second barrel side wall 15 to increase assembling stability. Preferably, an inner diameter of the second barrel side wall 15 is equal to or smaller than an outer diameter of the second optical member side wall 23 to prevent the at least one optical member 20 from moving toward the stage portion 13 excessively and further to maintain a distance between the first face 12 and the first stage face 131. In other embodiments, the second barrel side wall may be also non-abutted against the second optical member side wall.

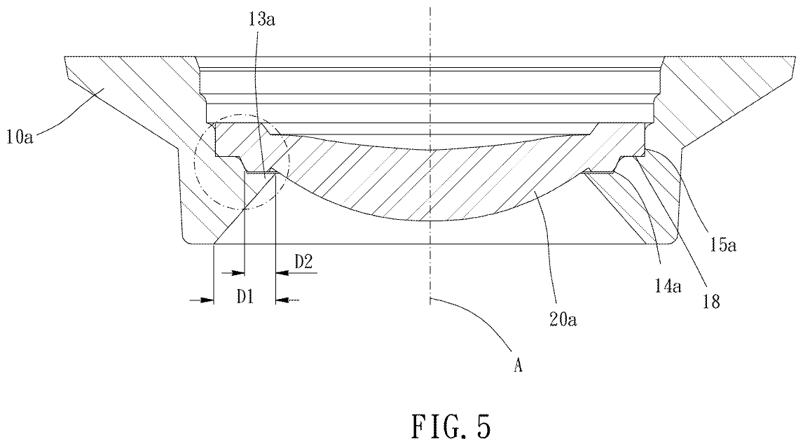

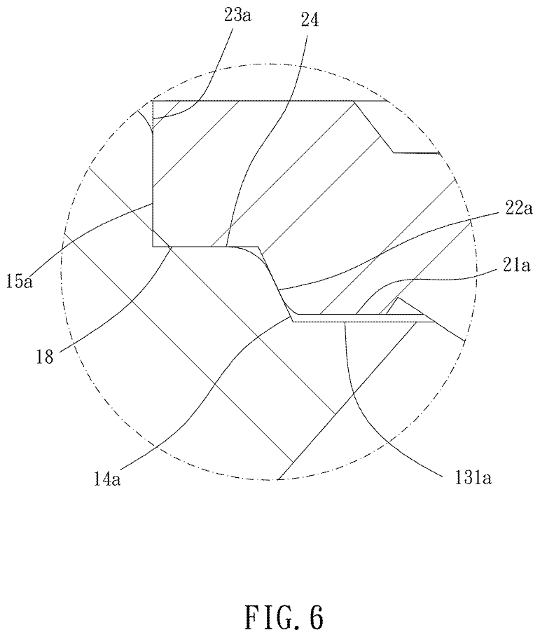

In a second preferred embodiment shown in FIGS. 5 and 6, the at least one optical member 20a further includes a second face 24 which is laterally connected to and between the second optical member side wall 23a and the first optical member side wall 22a, and an inner circumferential wall of the barrel 10a further includes a second stage face 18 which is lateral to the axial direction A and connected to the first barrel side wall 14a; when the first barrel side wall 14a is abutted against the first optical member side wall 22a, the second face 24 is abutted against the second stage face 18, and the second stage face 18 supports the at least one optical member 20a to effectively prevent the first stage face 131a from directly contacting the first face 21a and to provide preferable assembling stability. The second barrel side wall 15a and the second optical member side wall 23a are abutted against each other to increase a radial support and disperse a force along the axial direction A.

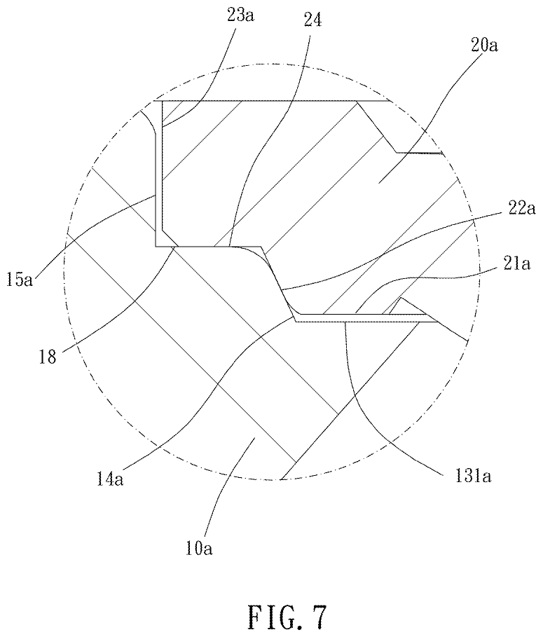

Please refer to FIG. 7 for a third preferred embodiment. Compared with the second preferred embodiment, when the first barrel side wall 14a is abutted against the first optical member side wall 22a, the second face 24 is abutted against the second stage face 18, and the second stage face 18 supports the at least one optical member 20a to prevent the first stage face 131a from directly contacting the first face 21a and to provide preferable assembling stability. The second barrel side wall 15a and the second optical member side wall 23a are spacingly arranged to have a greater range of tolerance, and it is convenient to mount the second barrel side wall 15a and the second optical member side wall 23a.

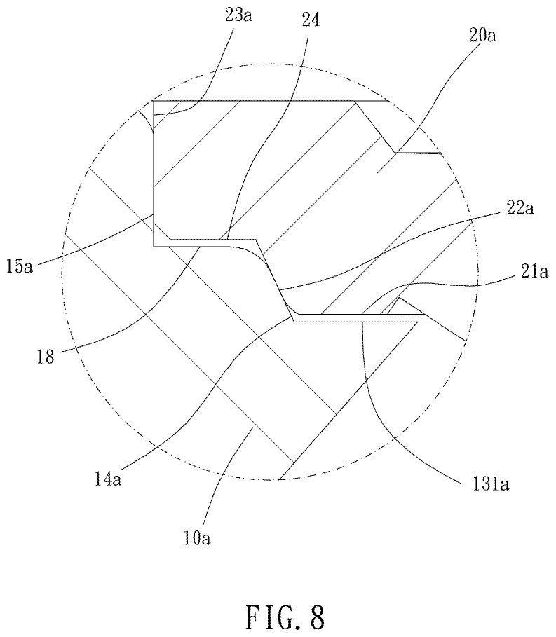

Please refer to FIG. 8 for a fourth preferred embodiment. Compared with the second preferred embodiment, when the first barrel side wall 14a is abutted against the first optical member side wall 22a, the second face 24 does not contact the second stage face 18, and the second barrel side wall 15a and the second optical member side wall 23a are abutted against each other to prevent the first stage face 131a from directly contacting the first face 21a, and a pressure of mounting the at least one optical member 20a can be obliquely dispersed through the first barrel side wall 14a and laterally dispersed through the second barrel side wall 15a, so as to largely decrease a force exerted on the stage portion 13a along the axial direction A to effectively prevent the stage portion 13a from force deformation.

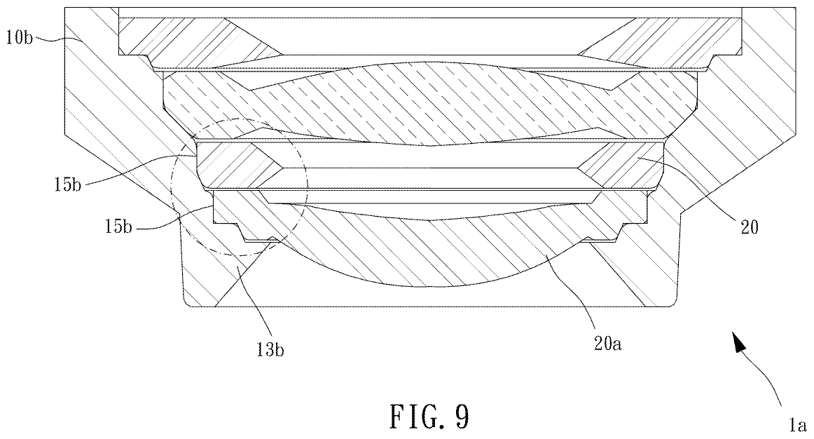

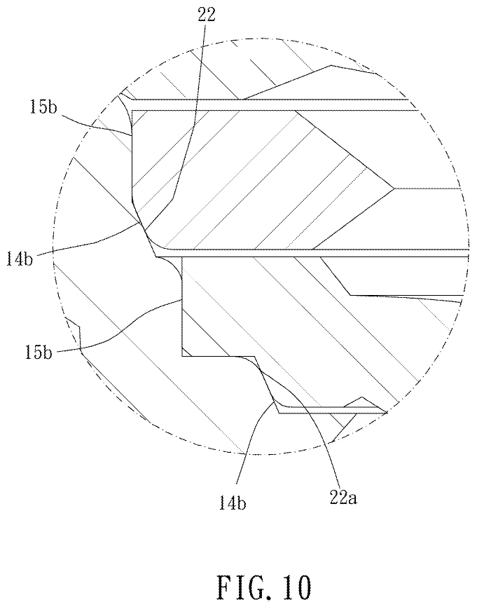

Please refer to a fifth preferred embodiment shown in FIGS. 9 and 10, the fifth preferred embodiment is a combination of the above mentioned first and second preferred embodiments. The lens assembly la includes the plurality of optical members 20, 20a, the plurality of optical members 20, 20a may include at least one of a lens, a spacer ring, an optical filter and a junk ring which can be arranged if needed. The inner circumferential wall of the barrel 10 further includes the plurality of first barrel side walls 14b and the plurality of second barrel side walls 15b which are located between two said first barrel side walls 14b neighboring to each other, the plurality of second barrel side walls 15b are steppedly arranged, the first optical member side wall 22, 22a of each said optical member 20, 20a is abutted against one said first barrel side wall 14b to prevent the stage portion 13b from force deformation and to prevent each said optical member 20, 20a from abutting against each other.

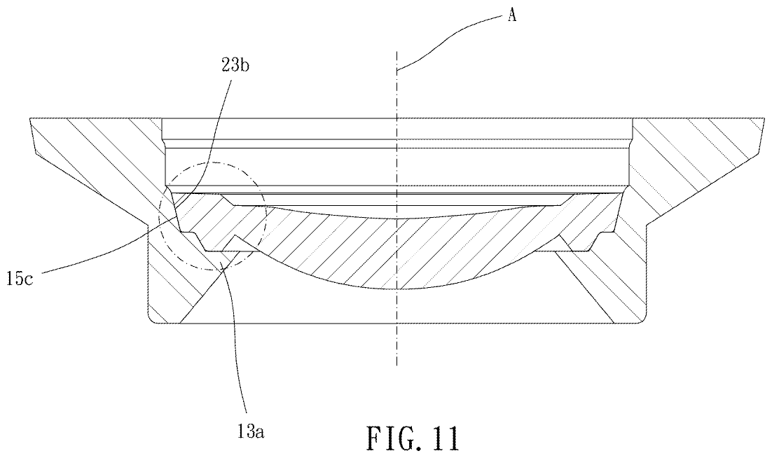

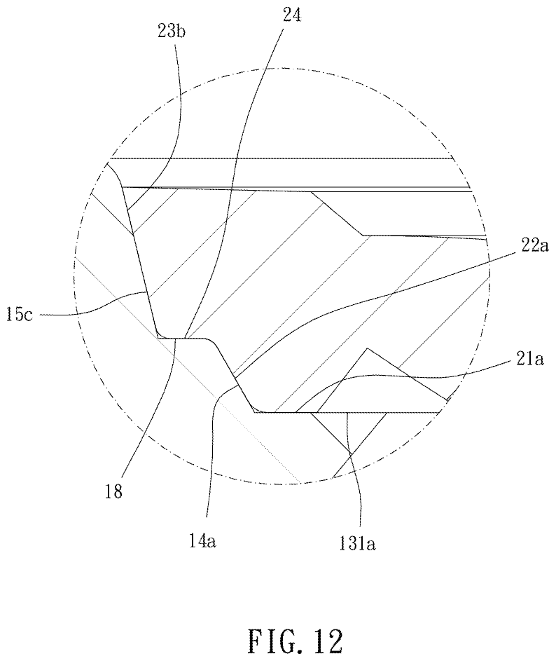

Please refer to FIGS. 11, 12 for a sixth preferred embodiment. Compared with the second preferred embodiment, the first stage face 131a is perpendicular to the axial direction A, the second barrel side wall 15c is oblique to the axial direction A, the inner circumferential wall of the barrel further includes a second stage face 18 which is perpendicular to the axial direction A and connected to and between the first barrel side wall 14a and the second barrel side wall 15c, and the first barrel side wall 14a is connected to and between the first stage face 131a and the second stage face 18. The second optical member side wall 23b and the second barrel side wall 15c are oblique relative to the axial direction A, and the second face 24 and the second stage face 18 are perpendicular to the axial direction A. When the first barrel side wall 14a is abutted against the first optical member side wall 22a, the second optical member side wall 23b and the second barrel side wall 15c are obliquely abutted against each other to radially disperse forces effectively, and the second face 24 and the second stage face 18 can be further abutted against each other on the axial direction A to prevent the first stage face 131a from taking too much force and to prevent the position of the stage portion 13a which is axially thinner from deformation. The first stage face 131a and the first face 21a positionably contact each other.

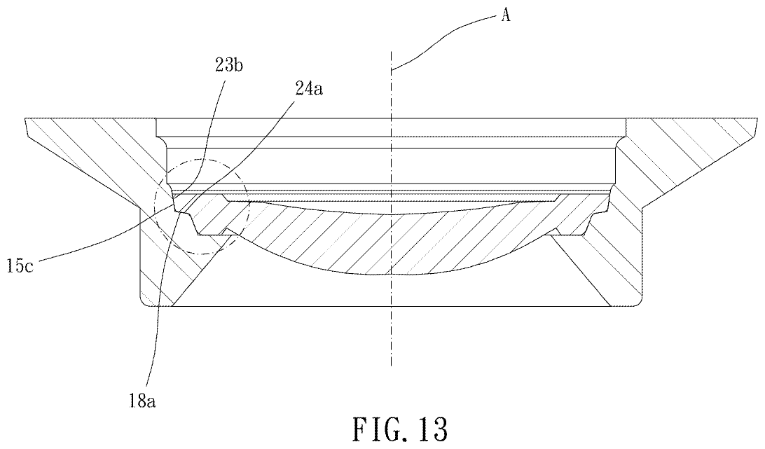

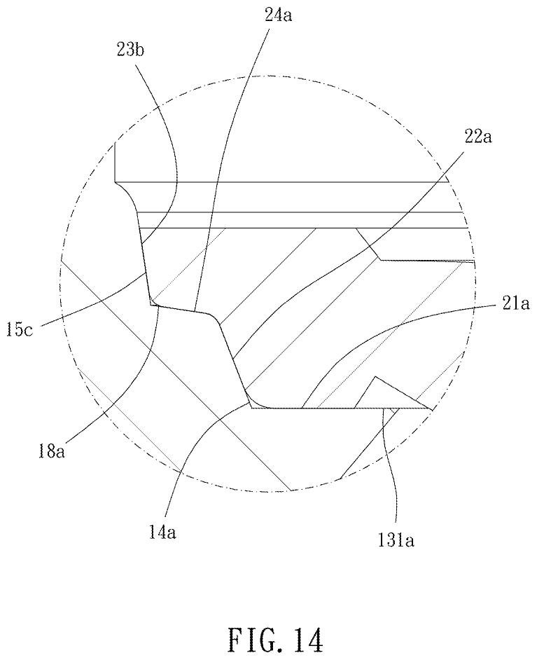

Please refer to FIGS. 13, 14 for a seventh preferred embodiment. Compared with the sixth preferred embodiment, the first stage face 131a is perpendicular to the axial direction A, the second barrel side wall 15c is oblique to the axial direction A, the inner circumferential wall of the barrel further includes a second stage face 18a which is oblique to the axial direction A and connected to and between the first barrel side wall 14a and the second barrel side wall 15c, and the first barrel side wall 14a is connected to and between the first stage face 131a and the second stage face 18a. Specifically, the second optical member side wall 23b, the second face 24a, the second barrel side wall 15c and the second stage face 18a are oblique to the axial direction A; when the first barrel side wall 14a is abutted against the first optical member side wall 22a, the second face 24a is obliquely abutted against the second stage face 18a, and the second optical member side wall 23b is obliquely abutted against the second barrel side wall 15c to effectively disperse the force along the axial direction A and to provide preferable assembling stability.

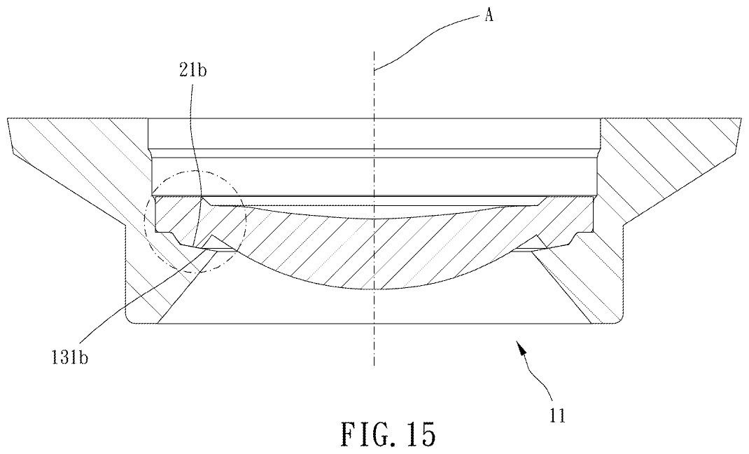

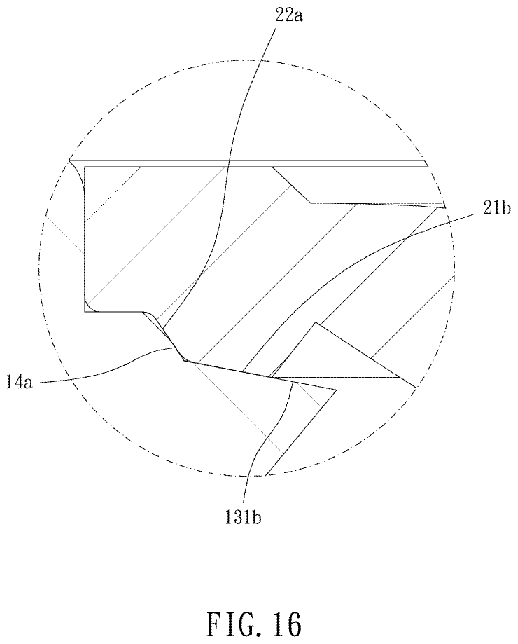

Please refer to FIGS. 15, 16 for an eighth preferred embodiment. Compared with the second preferred embodiment, the first stage face 131b extends obliquely toward the object side 11 relative to the axial direction A, the first stage face 131b and the first barrel side wall 14a have different slopes, and the first face 21b and the first stage face 131b extend toward the object side 11 relative to the axial direction A; when the first barrel side wall 14a is abutted against the first optical member side wall 22a, and the first face 21b is obliquely abutted against the first stage face 131b to disperse the force laterally or obliquely in order to prevent force deformation.

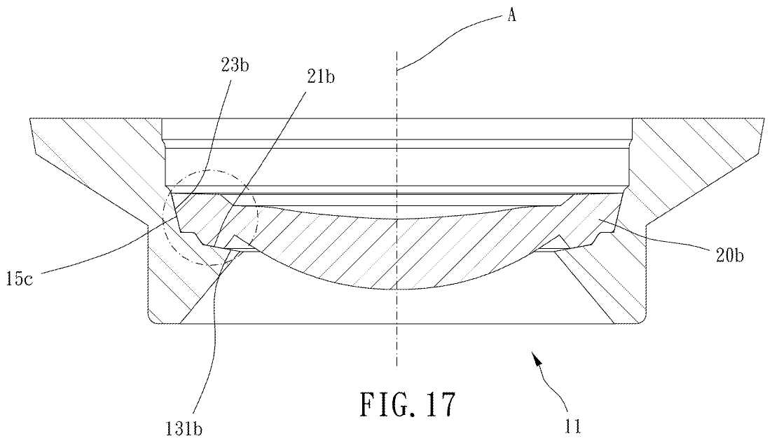

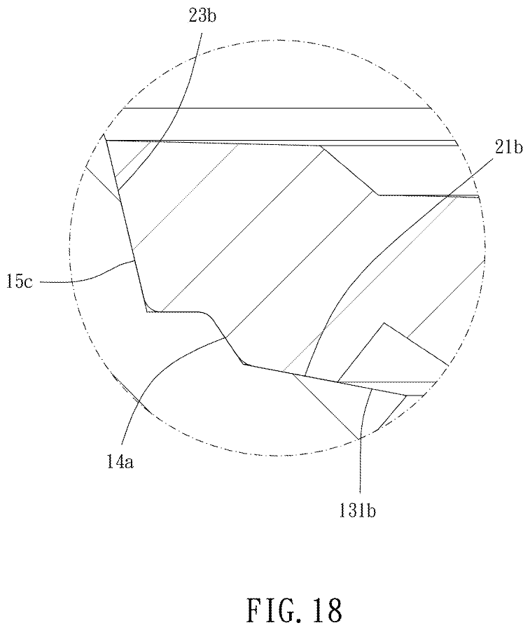

Please refer to a ninth preferred embodiment shown in FIGS. 17 and 18, the ninth preferred embodiment is a combination of the above mentioned sixth and eighth preferred embodiments. The second barrel side wall 15c and the second optical member side wall 23b obliquely extend relative to the axial direction A, the first face 21b and the first stage face 131b extend toward the object side 11 relative to the axial direction A, and the first barrel side wall 14a, the second barrel side wall 15c and the first stage face 131b obliquely support the at least one optical member 20b, so the pressure along the axial direction A can be effectively dispersed.

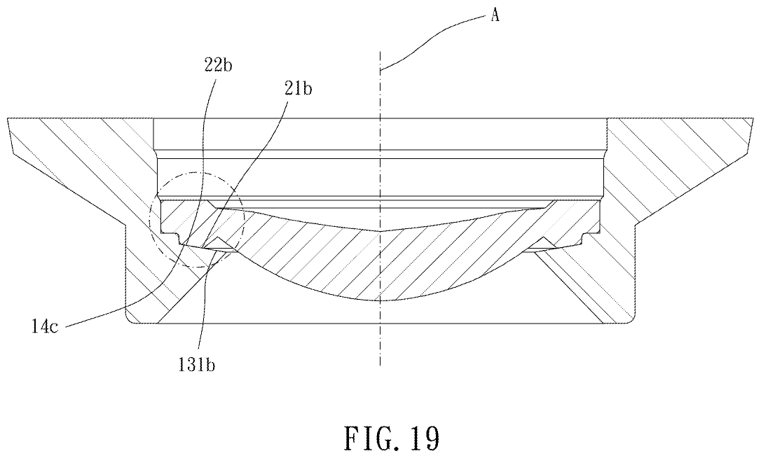

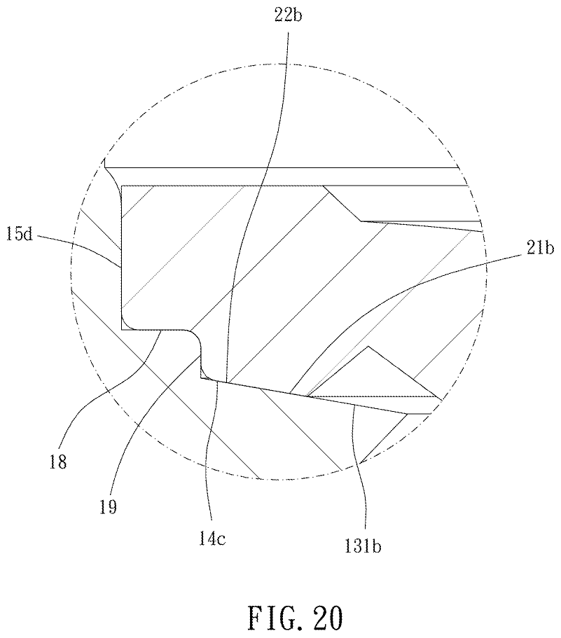

Please refer to FIGS. 19, 20 for a tenth preferred embodiment. Compared with the eighth preferred embodiment, the first stage face 131b extends obliquely toward the object side 11 relative to the axial direction A, the inner circumferential wall of the barrel further includes the second stage face 18 which is perpendicular to the axial direction A and connected to the second barrel side wall 15d and a third barrel side wall 19 which is connected to and between the second stage face 18 and the first barrel side wall 14c, the first barrel side wall 14c and the first stage face 131b are on a lowest face of the barrel (a same plane) and have same slopes, the first barrel side wall 14c and the first stage face 131b can be respectively viewed as a part of the lowest face of the barrel, and the first optical member side wall 22b and the first face 21b are on a same face of the optical member and have same slopes to disperse the force obliquely.

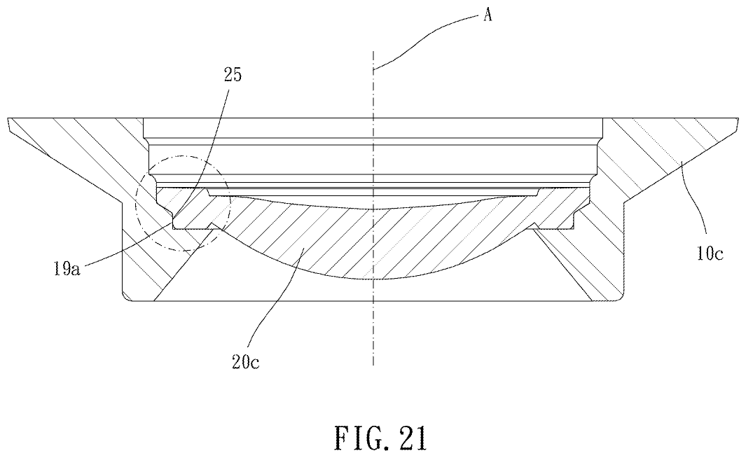

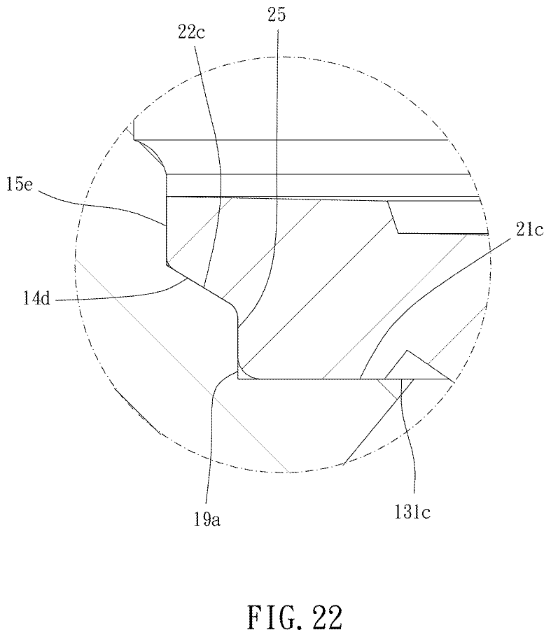

Please refer to FIGS. 21, 22 for an eleventh preferred embodiment. Compared with the first preferred embodiment, the second barrel side wall 15e is parallel to the axial direction A, the inner circumferential wall of the barrel 10c further includes the third barrel side wall 19a which is connected to and between the first barrel side wall 14d and the first stage face 131c, the at least one optical member 20c further includes a third optical member side wall 25 which is connected to and between the first optical member side wall 22c and the first face 21c, and the first barrel side wall 14d is connected to and between the second barrel side wall 15e and the third barrel side wall 19a. In this embodiment, the third barrel side wall 19a and the third optical member side wall 25 respectively extend along a direction parallel to the axial direction A; when the first barrel side wall 14d is abutted against the first optical member side wall 22c, the third barrel side wall 19a abuts against the third optical member side wall 25 to increase the radial support; the first stage face 131c contacts the first face 21c, and the assembling precision would be preferable.

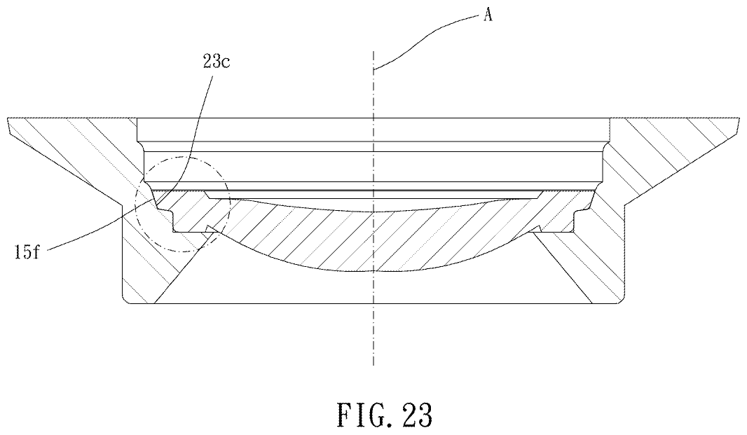

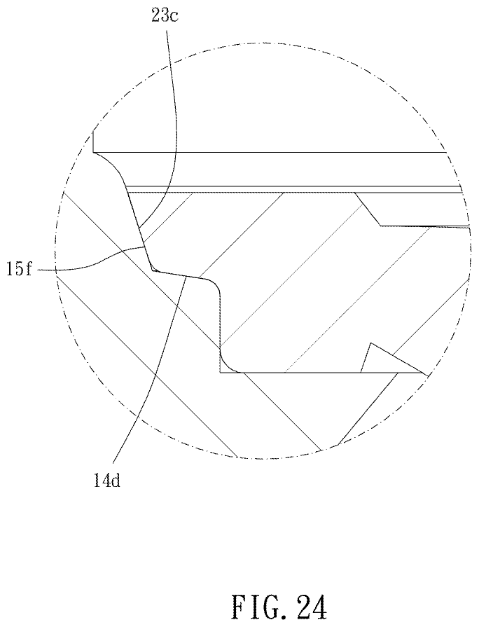

Please refer to FIGS. 23, 24 for a twelfth preferred embodiment. Compared with the eleventh preferred embodiment, the second barrel side wall 15f and the second optical member side wall 23c obliquely extend relative to the axial direction A, preferably, the first barrel side wall 14d and the second barrel side wall 15f extend relative to the axial direction A differently to provide support in different angles, so the stability and the force dispersion effect are preferable.

It is to be noted that in any of the above-mentioned embodiments, a transitional profile of the outer circumferential face of the optical member may be partly or completely correspond to a transitional profile of the inner circumferential face of the inner circumferential wall of the barrel.

While we have shown and described various embodiments in accordance with the present invention, it should be clear to those skilled in the art that further embodiments may be made without departing from the scope of the present invention.

What is claimed is:

1. A lens assembly, including:
a barrel, defining an axial direction, an object side, and an image side, an inner circumferential wall of the barrel including a stage portion extending inwardly, a first barrel side wall, and a second barrel side wall, wherein the stage portion including a first stage face facing toward the image side, the first barrel side wall being oblique to the axial direction and located between the first stage face and the second barrel side wall; and
at least one optical member mounted to the barrel, including a first face facing the first stage face and a first optical member side wall abutted against the first barrel side wall

2. The lens assembly of claim 1, wherein the stage portion further includes a slant face which is oblique to the axial direction and oppositely arranged to the first stage face, and a line which passes through an outer periphery of the slant face and is parallel to the axial direction is defined as a first straight line; and a point which the first barrel side wall contacts the first optical member side wall is defined as a contact position, a line which passes through the contact position and is parallel to the axial direction is defined as a second straight line, and a distance between the second straight line and an inner periphery of the stage portion is equal to or greater than ⅓ of a distance between the first straight line and the inner periphery of the stage portion.

3. The lens assembly of claim 1, wherein the first barrel side wall includes at least one of inclined plane, inclined convex surface or inclined concave surface which extends obliquely relative to the axial direction.

4. The lens assembly of claim 1, wherein the first barrel side wall includes at least one inclined plane, and an included angle between the at least one inclined plane and the axial direction is between 15 and 45 degrees.

5. The lens assembly of claim 1, wherein the at least one optical member further includes a second optical member side wall which extends along the axial direction, the first optical member side wall is connected to and between the second optical member side wall and the first face, and the second optical member side wall is abutted against the second barrel side wall.

6. The lens assembly of claim 5, wherein the second barrel side wall and the second optical member side wall are spacingly arranged to each other.

7. The lens assembly of claim 1, wherein the at least one optical member further includes a second optical member side wall which extends along the axial direction, and a second face which is laterally connected to and between the second optical member side wall and the first optical member side wall, and the inner circumferential wall of the barrel further includes a second stage face which is lateral to the axial direction and connected to the first barrel side wall; and when the first barrel side wall is abutted against the first optical member side wall, the second face is abutted against the second stage face.

8. The lens assembly of claim 2, wherein the first barrel side wall is transitionally connected to the first stage face; the first barrel side wall includes at least one of inclined plane, inclined convex surface or inclined concave surface which extends obliquely relative to the axial direction; the first barrel side wall includes at least one inclined plane, and an included angle between the at least one inclined plane and the axial direction is between 15 and 45 degrees, wherein the at least one optical member further includes a second optical member side wall which extends along the axial direction, the first optical member side wall is connected to and between the second optical member side wall and the first face, and the second optical member side wall is abutted against the second barrel side wall; an inner diameter of the second barrel side wall is equal to or smaller than an outer diameter of the second optical member side wall; a smallest inner diameter of the first barrel side wall is equal to or smaller than a smallest outer diameter of the first optical member side wall; the inner circumferential wall of the barrel further includes a plurality of annular walls which are steppedly arranged; and the slant face defines a light entrance hole which radially expands toward the object side.

9. The lens assembly of claim 1, wherein there is a gap between the first face and the first stage face.

10. The lens assembly of claim 1, wherein the first stage face is perpendicular to the axial direction, the second barrel side wall is oblique to the axial direction, the inner circumferential wall of the barrel further includes a second stage face which is perpendicular to the axial direction and connected to and between the first barrel side wall and the second barrel side wall, and the first barrel side wall is connected to and between the first stage face and the second stage face.

11. The lens assembly of claim 1, wherein the first stage face is perpendicular to the axial direction, the second barrel side wall is oblique to the axial direction, the inner circumferential wall of the barrel further includes a second stage face which is oblique to the axial direction and connected to and between the first barrel side wall and the second barrel side wall, and the first barrel side wall is connected to and between the first stage face and the second stage face.

12. The lens assembly of claim 1, wherein the first stage face extends obliquely toward the object side relative to the axial direction, the second barrel side wall is parallel to the axial direction, the inner circumferential wall of the barrel further includes a second stage face which is perpendicular to the axial direction and connected to and between the first barrel side wall and the second barrel side wall, and the first barrel side wall is connected to and between the first stage face and the second stage face.

13. The lens assembly of claim 1, wherein the first stage face extends obliquely toward the object side relative to the axial direction, the second barrel side wall is oblique to the axial direction, the inner circumferential wall of the barrel further includes a second stage face which is perpendicular to the axial direction and connected to and between the first barrel side wall and the second barrel side wall, and the first barrel side wall is connected to and between the first stage face and the second stage face.

14. The lens assembly of claim 1, wherein the first stage face extends obliquely toward the object side relative to the axial direction, the second barrel side wall is parallel to the axial direction, the inner circumferential wall of the barrel further includes a second stage face which is perpendicular to the axial direction and connected to and between the first barrel side wall and the second barrel side wall and a third barrel side wall which is connected to and between the second stage face and the first barrel side wall, and the first barrel side wall and the first stage face are on a same plane and have same slopes.

15. The lens assembly of claim 1, wherein the first stage face is perpendicular to the axial direction, the second barrel side wall is parallel to the axial direction, the inner circumferential wall of the barrel further includes a third barrel side wall which is connected to and between the first barrel side wall and the first stage face, the third barrel side wall is parallel to the axial direction, and the first barrel side wall is connected to and between the second barrel side wall and the third barrel side wall.

16. The lens assembly of claim 1, wherein the first stage face is perpendicular to the axial direction, the second barrel side wall extends obliquely relative to the axial direction, the inner circumferential wall of the barrel further includes a third barrel side wall which is connected to and between the first barrel side wall and the first stage face, the third barrel side wall is parallel to the axial direction, and the first barrel side wall is connected to and between the second barrel side wall and the third barrel side wall.
